(19) United States
(12) Patent Application Publication
(10) Pub. No.: US 2011/0265456 A1
(43) Pub. Date: Nov. 3, 2011

(54) Diesel Engine and Method for Flexible Passive Regeneration of Exhaust After-Treatment Devices

(75) Inventors: Scott B. Fiveland, Metamora, IL (US); Christopher R. Gehrke, Chillocothe, IL (US)

(73) Assignee: CATERPILLAR, INC., Peoria, IL (US)

(21) Appl. No.: 12/770,470

(22) Filed: Apr. 29, 2010

(51) Int. Cl. F02D 28/00; F02B 27/04

(52) U.S. Cl. 60/285; 60/273

(57) ABSTRACT

A diesel engine and method for operating a diesel engine with exhaust after-treatment device regeneration capability are disclosed. The diesel engine may employ an exhaust after-treatment device such as a diesel particular filter to remove soot from the combustion gases exhausted by the engine. In order to regenerate the exhaust after-treatment device, the temperature of the exhaust gases is raised sufficiently to do so. The temperature of the exhaust gases is raised to such a level by employing multiple compression and expansion strokes of the piston in certain engine cycles, with a combustion event associated with each pair of compression and expansion strokes. The engine may operate in a four stroke, one combustion cycle during conventional power operation, and switch to an enhanced combustion cycle during regeneration. The enhanced combustion cycle may include eight strokes such as one intake stroke, three compression strokes, three expansion strokes, and one exhaust stroke, with three combustion events. The engine may switch between cycles by using a cam follower with lost motion device capability, an electrical actuator, or any other selectively actuable valve actuator to prevent opening of the intake and exhaust valves during regeneration.

### TECHNICAL FIELD

The present disclosure generally relates to diesel engines, and more particularly relates to regeneration of exhaust gas after-treatment devices used in diesel engines.

### BACKGROUND

Diesel engines are a common form of internal combustion engine. They typically employ a four stroke cycle in normal operation. Those four strokes include intake, compression, expansion and exhaust. During the intake stroke, air is drawn into the combustion cylinder. During the compression stroke, the air is compressed by a piston. During the expansion stroke, fuel that was injected into the cylinder during the latter part of the compression stroke is ignited by the compressed and heated air. During the exhaust stroke, the products of combustion are expelled from the cylinder. As one of ordinary skill in the art will recognize, this is different from an Otto cycle internal combustion engine in that a spark plug is not used, rather the air is compressed to such a degree and temperature that the atomized diesel fuel injected into the cylinder is able to instantaneously ignite.

In other diesel engine cycles it is known to have six, eight, or more strokes and up to two combustion strokes. For example, US Pat. No. 6,443,108 discloses a diesel engine which uses eight strokes total, with two combustion events leading to expansion strokes as part of the eight. The first combustion is performed at a lean air-fuel ratio, and the second combustion is performed at a stoichiometric air-fuel ratio, with the purported benefit being that the first combustion provides high efficiency, and the second allows for high conversion efficiency of nitrogen oxides. While additional compression and expansion strokes are included as part of the overall engine cycle, combustion events do not occur between each compression and expansion stroke.

While diesel engines are generally effective and highly successful, one drawback to diesel engines has been the particulates or soot expelled with the exhaust of the products of combustion. As environmental concerns and requirements have become increasingly stringent, structure has had to be added to the engine and new approaches have had to be created to lessen the pollutants released with the exhaust. Those approaches have included but are not limited to the use of catalytic converters and exhaust gas recirculation (EGR).

Another approach has involved the use of exhaust gas after-treatment devices such as a diesel particulate filter (DPF) downstream of the engine exhaust. DPF technology forces the combustion gases through a porous material to collect the soot. Usually between 85% and 99% of the particulates can be removed by a DPF. There are many different materials from which a DPF can be manufactured including, but not limited to, cordierite, silicon carbide, ceramic fibers, and metal fibers. Still other exhaust gas after-treatment devices exist such as, but not limited to, selective catalytic reduction (SCR) devices for reducing nitrous oxide emissions, and diesel oxidation catalyst (DOC) devices for reducing carbon monoxide and hydrocarbon emissions.

With specific reference to diesel particulate filters, while they are effective in removing the soot, they need to be regenerated from time to time to remove the accumulated soot. This can be performed either passively (by adding a catalyst to the filter) or actively (by raising the temperature of the exhaust gas). Catalysts are effective but add expense to the system. Raising the temperature of the exhaust temperature is also effective, but also adds expense to the system. For example, it has been known to raise the temperature of the exhaust gases by using resistive coils or microwave energy. Both approaches, however, not only require additional structure in terms of either the coils or microwave generator, but require additional energy as well.

Another passive approach to regenerate the DPF is to add a fuel burner or combustor downstream of the engine exhaust, and upstream of the DPF. This combustor uses additional fuel to generate heat and thus raise the temperature of the exhaust gases to a high enough level to regenerate the DPF (typically above 600° F.). Known by the present assignee as CRS (Caterpillar Regeneration System), this approach is also very effective in regenerating the DPF, but not only requires additional structure in terms of the combustor, but requires additional fuel as well.

### SUMMARY OF THE DISCLOSURE

In accordance with one aspect of the disclosure, a method of operating an internal combustion engine with an exhaust after-treatment system is disclosed which comprises operating the engine in a four stroke, one combustion mode, changing operating modes to an eight-stroke, three combustion mode in response to a first trigger associated with a condition of the exhaust after-treatment system, and changing operating modes back to the four stroke, one combustion mode in response to a second trigger associated with a condition of the exhaust after-treatment system.

In accordance with another aspect of the disclosure, a method of regenerating a exhaust after-treatment device is disclosed, comprising connecting the exhaust after-treatment device downstream of a diesel engine exhaust, and raising the temperature of gases passing through the exhaust after-treatment device to a level sufficient to remove particulates accumulated on the exhaust after-treatment device, the temperature being raised by employing sets of additional compression and expansion strokes in the diesel engine, with each set of compression and expansion strokes being associated with an additional combustion event.

In accordance with another aspect of the disclosure, a diesel engine is disclosed, comprising a cylinder, a piston reciprocatingly mounted within the cylinder, an intake valve operatively associated with the cylinder, an exhaust valve operatively associated with the cylinder, a exhaust after-treatment device connected downstream of the exhaust valve, a selectively actuable valve actuator associated with each of the intake and exhaust valves, and a processor causing the engine to employ an enhanced combustion cycle when regeneration of the exhaust after-treatment device is desired.

### BRIEF DESCRIPTION OF THE DRAWINGS

FIG. 1 is a schematic representation of a diesel engine constructed in accordance with the teachings of this disclosure;

FIG. 2 is a flow chart of a sample sequence of steps which may be practiced in accordance with the teachings of this disclosure;

FIG. 3 is a cut-away view of a cylinder head and valve lifter constructed in accordance with the teachings of this disclosure; and

FIG. 4 is a sectional view of one embodiment of a lost motion device constructed in accordance with the teachings of the disclosure.

### DETAILED DESCRIPTION

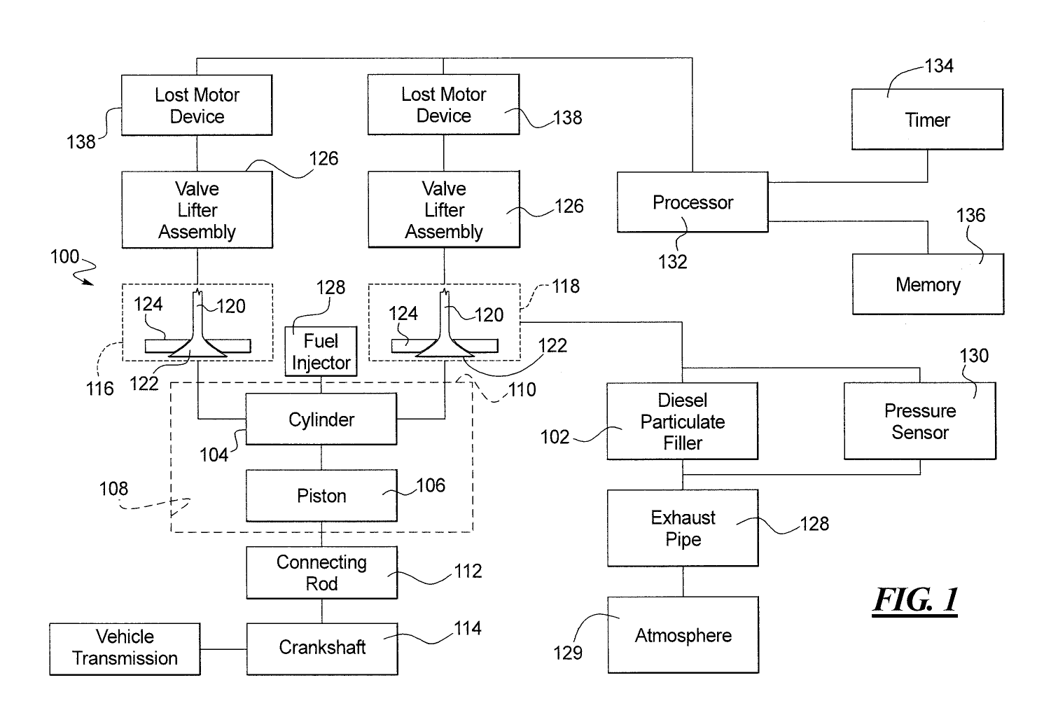

Referring now to the drawings, and with specific reference to FIG. 1, an engine constructed in accordance with the teachings of this disclosure is generally referred to by reference numeral 100. The engine 100 may be a diesel engine of the type using an exhaust after-treatment device 102 to remove soot and other products of combustion from the exhaust gases of the engine 100 prior to being released to the atmosphere. For example, the exhaust after-treatment device 102 may include, but not be limited to, diesel particulate filters (DPF), selective catalytic reductions devices (SCR), and diesel oxidation catalyst devices (DOC).

Such exhaust after-treatment devices 102 can be used in isolation or in combination, with one configuration having a DOC upstream of a DPF upstream of a SCR, each of which will be explained in greater detail below.

The engine 100 may include a plurality of cylinders 104 in which a piston 106 reciprocates, with the space therebetween defining a combustion chamber 108. The cylinder 104 may be closed on one end with a cylinder head 110. A connecting rod 112 may extend from a base of the piston 106 to a crankshaft 114. As will be readily understood by one of ordinary skill in the art, the rotational force of the crankshaft can then be used to provide locomotion to a vehicle, drive a transmission, power implements, or the like.

Within the cylinder head 110, an intake valve 116 and exhaust valve 118 are reciprocatingly mounted. More specifically, each valve 116 and 118 may include a valve stem 120 from which extends a valve head 122. The valve heads 122 are adapted to fit against valve seats 124 provided in the cylinder head 110 when closed, and move away from the valve seats 124 when opened. Movement of the valves 116 and 118 may be controlled by valve lifter assemblies 126 as will be described in further detail herein.

The cylinder head 110 may also mount one or more fuel injectors 128 toward the combustion chamber 108. As one of ordinary skill in the art will readily understand, typical diesel engines operate on a four-stroke cycle, with those four strokes including intake, compression, expansion, and exhaust. During the intake stroke, the intake valve 116 is open and the exhaust valve 118 is closed while the piston 106 descends away from the cylinder head 110, thereby allowing air into the combustion chamber 108. During the compression stroke, the piston 106 moves toward the cylinder head 110 while the intake valve 116 and exhaust valve 118 are closed, thereby compressing the air within the combustion chamber 108. During the latter stages of the compression stroke, e.g., the last fifteen to twenty degrees of motion before the piston 106 reaches a top dead center position within the cylinder 104, diesel fuel is injected by the fuel injectors 128 into the compressed air while the intake valve 116 and exhaust valve 118 remain closed. The highly compressed air is heated by the compression to a temperature high enough to spontaneously combust the diesel fuel upon injection. This in turn forces the piston 106 to again descend away from the cylinder head 110 in an expansion. During the exhaust stroke, the piston returns toward the cylinder head 110 with the exhaust valve 118 open to thereby expel combustion gases and particulates from the combustion chamber 108. In alternative embodiments, a premixed combustion strategy could be employed wherein a portion of the fuel is injected as early as forty degrees or the like before top dead center, or early in the expansion stroke as well, especially during the second or subsequent combustion events.

While the foregoing description of a four-stroke diesel engine cycle is well known, the present disclosure departs from conventional diesel engines in many ways, one of which is providing for the use of additional combustion events during an engine cycle having an increased number of overall strokes so as to raise the temperature of the exhausts gases to a level high enough to cause regeneration of the exhaust after-treatment device 102. This is a significant departure from the prior art, including the '108 patent mentioned in the background section of the present disclosure. Whereas the '108 patent discloses six, eight or more overall steps, it only discloses two combustion events. This is not surprising in that the '108 patent is not concerned with raising exhaust gas temperature, but rather just with have a first combustion event at one air-fuel ratio and a second combustion event at a different air-fuel ratio.

As mentioned above, the engine 100 includes an exhaust after-treatment device 102 downstream of the exhaust valve 118 and upstream of an exhaust pipe 128 where combustion gases are released to the atmosphere 129. While the exhaust after-treatment device 102 is effective at removing soot and other particulates from the exhaust, the exhaust after-treatment device 102 must periodically be regenerated to remove the soot and particulates filtered from the exhaust. The present disclosure uses additional sets of compression and expansion strokes in each engine cycle, with a combustion event associated with each set, so as to raise the temperature of the combustion gases released by the exhaust valve 118 and directed toward the exhaust after-treatment device 102.

When regeneration of the exhaust after-treatment device 102 is necessary can be determined any number of different ways, with multiple exemplary methods being described herein. In a first embodiment depicted in FIG. 1, a pressure sensor 130 can be provided to measure a pressure drop Δ_{P} across the exhaust after-treatment device. If the Δ_{P} is above a predetermined value, a processor 132 in communication with the pressure sensor 130 may cause the engine 100 to switch to an enhanced combustion cycle. As used herein, “enhanced combustion cycle” means a diesel engine cycle employing at least one intake stroke, two or more compression strokes, two or more expansion strokes, and at least one exhaust stroke, with a combustion event occurring between each compression and expansion stroke. Examples would include an 8 stroke with 3 combustion events cycle including intake, compression (concluded with combustion), expansion, compression (concluded with combustion), expansion, compression (concluded with combustion), expansion, and exhaust strokes in that order.

In alternative embodiments, 6, 10 or more stroke cycles may be used. The number of strokes used may depend on the resulting temperature of the combustion gases exhausted to the exhaust after-treatment device 102. In order to regenerate such filters 102, the temperature of the combustion gases must typically be 600° F. or more, but if regeneration can be accomplished at a lower temperature, or such a temperature can be attained with fewer strokes and combustion events, the resulting cycle may vary. Conversely, if the particular type of exhaust after-treatment device 102 used needs to have even higher gas temperatures in order to regenerate, additional strokes and combustion events may be required.

In another embodiment, the determination that regeneration is required may not depend on the pressure drop Δ_{P} across the exhaust after-treatment device 102, but rather could be based on an elapsed time since the last regeneration. In such an embodiment, a timer 134 may be provided in communication with the processor 132. A memory 135 may also be provided to, among other things, store the elapsed time since regeneration, or store different algorithms for determining when regeneration is required.

In a still further embodiment, radio-frequency (RF) sensor technology may be used. More specifically, a radio-frequency transmitter 136 may be provided on one side of the exhaust after-treatment device 102 with a radio-frequency receiver 137 provided on the opposite side. In such an arrangement, the RF transmitter 136 may emit a signal that is received by the RF receiver 137. However, the amount of soot present in the exhaust after-treatment device 102 will affect the strength of the received signal. The signal will thus continue to attenuate over time as the soot builds up. Eventually, the signal strength will weaken to a threshold value suggesting the exhaust after-treatment device 102 should be regenerated. That threshold value can be stored in memory 135 and the measured signal strength can be continually compared thereto by the processor 132, with the processor initiating an enhanced combustion cycle with regeneration is required.

The triggers for other exhaust after-treatment devices may be different. For example, with a DOC or SCR, a trigger may be the measured effectiveness of the catalyst to reduce emission. More specifically, with a SCR, the measured NOₓ output could be the trigger, while with a DOC, measured carbon monoxide (CO) or hydrocarbon (HC) levels could serve as the trigger. Accordingly, the processor 132 could compare the measured value relative to a threshold value and initiate regeneration when that threshold is crossed.

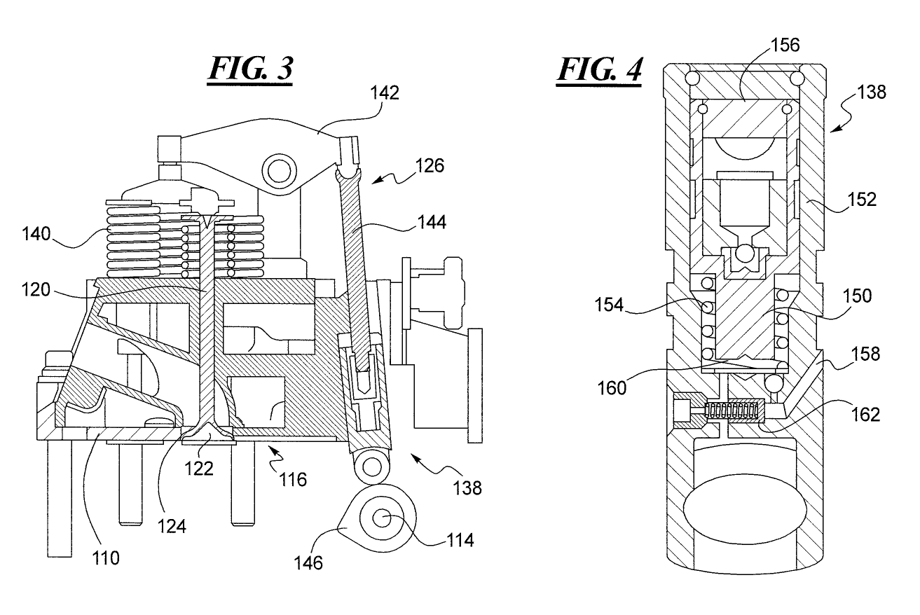

When the processor 132 determines that regeneration is required, using any of the foregoing methods, the processor 132 may switch the engine 100 from a four-stroke, one combustion cycle, to an eight-stroke, three combustion cycle or some other enhanced combustion cycle. It may do so by employing, for example, any number of different lost-motion devices operatively associated with each of the valve lifter assemblies 126. As used herein, “lost-motion device” means any type of structure which receives input energy but selectively provides output energy. An exemplary embodiment of one is shown in FIGS. 3 and 4.

As depicted therein, the lost-motion device may be provided as a cam follower 138 with lost motion capability, and as part of the valve lifter assembly 126. More specifically, the valve stems 120 of the intake valve 116 and exhaust valve 118 may be biased into a closed configuration by a spring 140 provided atop the cylinder head 110. When it is desired to open one of the valves 116, 118, a rocker arm 142 rotates (counterclockwise in FIG. 3) so as to depress the spring 140 and valve stem 120. The rocker arm 142 is caused to so rotate by reciprocating motion of a rod 144 and the direction of a rotating cam 146. The cam 146 is mounted onto a camshaft 148 which rotates with the crankshaft 114. Here, it is important to note that the foregoing describes an overhead valve style engine, but that the lost motion device could easily be designed to function with an overcam design as well, among others.

If the rod 144 were simply a solid piece of metal, the valves 116, 118 would open every time the cam 146 makes a revolution and be returned to a closed position by the spring 140 every time the cam 146 passes the rod 144. However, the cam follower with lost motion capability 138 may be provided to selectively cause the valves 116 and 118 to stay closed when desired. More specifically, as shown best in FIG. 4, the cam follower with lost motion capability 138 may include a piston 150 slidable within a cylinder 152 and separated by a spring 154. The piston 50 may include a rod seat 156 adapted to receive the valve rod 144 as shown best in FIG. 3. This arrangement provides a certain amount of play so that when the cam 146 rotates it pushes the cylinder 152 up and compresses the spring 154. As the spring 154 is there to absorb the motion of the cylinder 152, the piston 150 does not move and neither does the rocker arm 142, thus keeping the valves 116, 118 closed. In other words, the spring 154 does not overcome the force of the spring 140 to open the valve, thus the cylinder 152 moves relative to the piston 150.

However, when it is desired to have the cam 146 open the valves 116 or 118, hydraulic fluid such as engine oil is caused to enter the lost motion device 138 at inlet port 158. As shown in FIG. 4, inlet port 158 is connected to a lifter space 160 below the piston 150 and held there under pressure by a quick dump valve 162. The fluid pressure moves the valve 162 to the left (in FIG. 4) to block the exit passage from the lifter space 160. As long as oil is communicated to the lifter space 160 and held there under pressure by the dump valve 162, the piston 150 and cylinder 152 are held rigidly in place relative to each other and the play afforded by the spring 154 is ineffectual. Accordingly, when the cam 146 rotates into engagement with the cylinder 152 it is moved upward and so too is the piston 150 and rod 144. Upward movement of the rod 144 causes the rocker arm 142 to pivot and thus the valves 116 or 118 to open.

In alternative embodiments, a mechanical lost-motion device need not be employed. For example, the foregoing arrangement may only allow for engine cycles which have a multiple of four strokes, e.g., four, eight or twelve strokes. If other cycles, such as six, ten, or the like are desired, or for other reasons, a different configuration to keep the valves closed when desired may be employed. Such arrangements may include the use of an electrically actuated valve 163, i.e, one which selectively opens only upon receipt of a signal from the processor 132. In other embodiments, other forms of selectively actuable valve actuators such as the cam follower with lost motion capability 138 and electrical valve actuator 163, and others, may be employed. As used herein, a “selectively actuable valve actuator” is one which can be controlled so as to open the intake and exhaust valves only as needed for an enhanced combustion cycle, as opposed to every time the camshaft 148 of the engine rotates.

With such structure in place the engine 100 is able to operate in a conventional four-stroke, one combustion cycle for normal operation, or be switched to an eight-stroke, three combustion cycle or other enhanced combustion cycle when exhaust after-treatment device regeneration is desired. All that needs to be done is for the processor 130 to cause the cam follower with lost-motion capability 138, electrical valve actuator 163, or other selectively actuable valve actuator, to be engaged or disengaged as appropriate. In the depicted mechanical example, this means that the hydraulic fluid is introduced to the lifter space 160 and the dump valve 162 is held closed when the lost-motion device is engaged, but in other embodiments any number of other forms of lost motion devices including but not limited to springs, one-way clutches, ratchets and the like are possible.

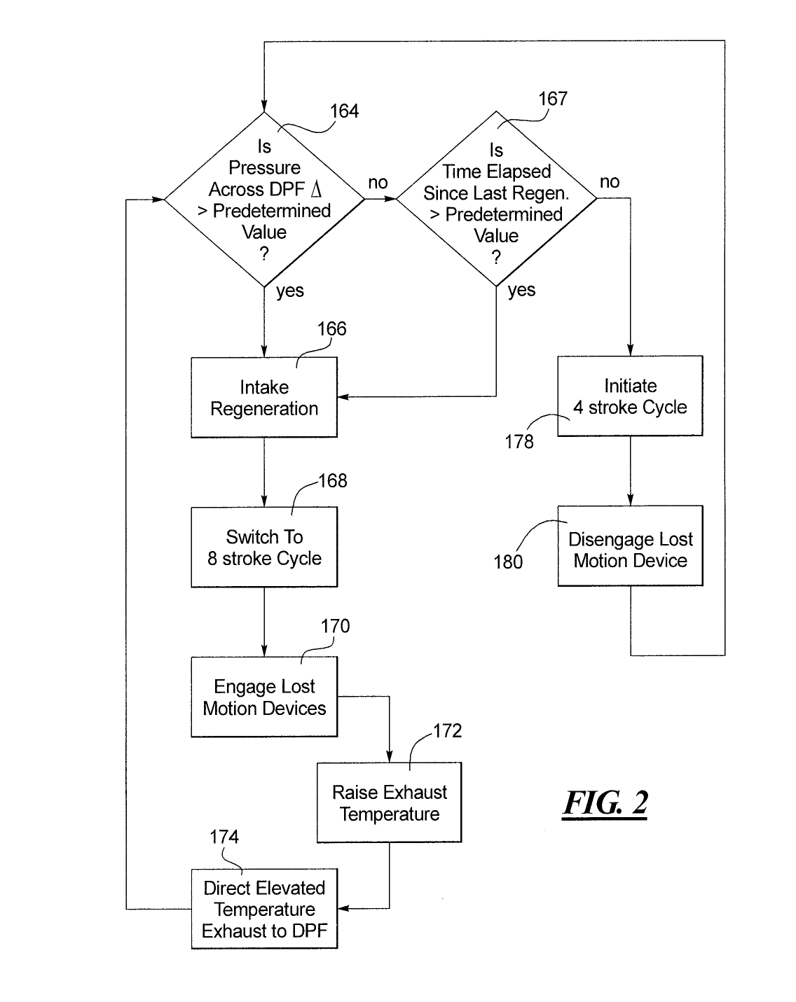

In operation, the method of engine operation and exhaust after-treatment device regeneration as taught by the present disclosure is set forth in flowchart format in FIG. 2. As shown therein, a first step 164 may be to for the processor 132 to decide if a Δ_{P} across the exhaust after-treatment device 102 is above a predetermined value. If this trigger is met, as shown in step 166, this would indicate that the exhaust after-treatment device 102 is becoming saturated and needs to be regenerated. Of course, in alternative embodiments, other triggers, including but not limited to the elapsed time, RF signal strength, and measured nitrous oxide, carbon monoxide and hydrocarbon embodiments disclosed above, could be used. This begins by having the processor 132 switch the engine 100 to an eight-stroke or other enhanced combustion cycle as shown by step 168. In so doing, the cam follower with lost motion capability 138 is selectively engaged as in step 170 so as to keep the valves 116 and 118 closed during the second, third or more sets of compression and expansion strokes, each with a combustion event therebetween. This in turn causes the temperature of the combustion gases within the combustion chamber 108 to rise as indicated in step 172 to a temperature high enough to remove the soot when directed to the exhaust after-treatment device 102 in a step 174.

As shown, this monitoring of the Δ_{P} across the exhaust after-treatment device 102 is continual as immediately after the elevated temperature gases are directed through the exhaust after-treatment device 102, the method reverts to step 164 to again determine if the Δ_{P} across the exhaust after-treatment device 102 is above a predetermined level. Eventually, sufficient soot will be removed from the exhaust after-treatment device 102 so as to drop the Δ_{P} thereacross to below the predetermined level.

Either in addition to, or in lieu of, the pressure drop determination step 164, the method can also determine if regeneration is needed based on an elapsed time since the last regeneration. This trigger is shown by step 176. For example, if the engine manufacturer knows that regeneration should occur after each X number of hours of engine operation, once that threshold is passed, regeneration can be initiated. In such case, the method will then revert to step 166.

In the alternative, if the time since the last regeneration has not yet surpassed the predetermined level and the pressure drop Δ_{P} across the exhaust after-treatment device is not above a predetermined level, the processor 132 may determine that the eight-stroke or other enhanced combustion cycle is not necessary and revert to normal four-stroke cycle operation as indicated in a step 178. This in turn means that, in the depicted embodiment, the dump valve 162 is opened and thus the lost motion device 138 is disengaged (see step 180) so that the valves 116 and 118 can open with each revolution of the cam 146.

In the still further alternative, the strength of the RF signal received can be compared to a threshold value stored in the memory as indicated at a step 182. If the signal strength is sufficiently weak this will suggest regeneration is necessary and the enhanced combustion cycle can commence as indicated in step 166. This will continue until the RF signal strength returns to strength above the threshold, where at normal four stroke operation can resume as indicated by step 178.

### INDUSTRIAL APPLICABILITY

From the foregoing, it can be seen that the technology disclosed herein has industrial applicability in a variety of settings such as, but not limited to, operating a diesel engine so as to regenerate an exhaust after-treatment device when desired. As opposed to using costly additional structures such as a combustor downstream of the engine exhaust and upstream of the exhaust after-treatment device, or microwave generators or resistive coils similarly positioned, the present disclosure allows the elevated temperature gases to be generated directly in the combustion chambers of the engine cylinders and directly communicated to the exhaust after-treatment devices. In so doing, not only is the cost of the additional structure of the prior art avoided, but the additional fuel or energy those prior art systems require is avoided as well to result in a more efficient system.

The teachings of this disclosure can be employed on any newly manufactured diesel engine or be retrofitted to existing engines simply through the addition of a lost-motion device, electrical valve actuator, or the like, and programming of the engine processor to determine when regeneration is required and when to engage and disengage the structure to implement the regeneration.

By employing the teachings of the present disclosure, a cost-effective approach is provided to operate a diesel engine and regenerate an exhaust after-treatment device associated therewith. Accordingly, current environmental regulations for exhaust gases of diesel engines can be met.

What is claimed is:

1. A method of operating an internal combustion engine with an exhaust after-treatment system, comprising:
operating the engine in a four stroke, one combustion mode;
changing operating modes to an eight-stroke, three combustion mode in response to a first trigger associated with a condition of the exhaust after-treatment system; and
changing operating modes back to the four stroke, one combustion mode in response to a second trigger associated with a condition of the exhaust after-treatment system.

2. The method of claim 1, wherein the first trigger occurs when a pressure drop across an exhaust after-treatment device of the engine exceeds a predetermined level.

3. The method of claim 1, wherein the first trigger occurs when a time elapsed since a last regeneration is exceeded.

4. The method of claim 1, wherein the second trigger occurs when a pressure drop across a exhaust after-treatment device of the engine exceeds a predetermined level.

5. The method of claim 1, wherein the second trigger occurs when a time elapsed since a last regeneration is exceeded.

6. The method of claim 1, wherein the first and second triggers relate to a relative strength of an RF signal.

7. The method of claim 1, wherein operating the engine in the eight-stroke, three combustion mode includes using at least one lost motion device to selectively disable operation of at least one of an exhaust valve and intake valve.

8. The method of claim 7, wherein the lost motion device is a cam follower which operatively disconnects a rotating cam of the engine from a valve lifter assembly connected to one of the exhaust valve and intake valve.

9. The method of claim 1, wherein operating the engine in the eight-stroke, three combustion mode includes using an electrical valve actuator to selectively disable operation of at least one of an exhaust valve and intake valve.

10. A method of regenerating a exhaust after-treatment device, comprising:
providing the exhaust after-treatment device downstream of a diesel engine exhaust valve; and
raising the temperature of gases passing through the exhaust after-treatment device to a level sufficient to remove particulates accumulated on the exhaust after-treatment device, the temperature being raised by employing additional sets of compression and expansion strokes in the engine, with each set of compression and expansion strokes being associated with an additional combustion event.

11. The method of claim 10, wherein the engine employs at least one intake stroke, two compression strokes, two expansion strokes, one exhaust stroke, and two combustion events, with each set of compression and expansion strokes having a combustion event therebetween.

12. The method of claim 10, wherein the engine employs at least one intake stroke, three compression strokes, three expansion strokes, one exhaust stroke, and three combustion events with each set of compression and expansion strokes having a combustion event therebetween.

13. The method of claim 10, further including employing a cam follower with lost motion capability to keep intake and exhaust valves of the engine closed during the additional compression and expansion strokes, the cam follower with lost motion capability operatively disconnecting rotating cams of the engine from valve lifter assemblies connected to the intake and exhaust valves.

14. The method of claim 10, further including employing an electrical valve actuator to keep intake and exhaust valve of the engine closed during the additional compression and expansion strokes.

15. The method of claim 10, wherein the raising step is performed whenever a pressure drop across the exhaust after-treatment device is above a predetermined level.

16. The method of claim 10, wherein the raising step is performed whenever a time duration between regenerations of the exhaust after-treatment device is above a predetermined level.

17. The method of claim 10, wherein the raising step is performed whenever an RF signal associated with the exhaust after-treatment device is below a predetermined level.

18. A diesel engine, comprising:
a cylinder;
a piston reciprocatingly mounted within the cylinder;
an intake valve operatively associated with the cylinder;
an exhaust valve operatively associated with the cylinder;
a exhaust after-treatment device connected downstream of the exhaust valve;
a selectively actuable valve actuator associated with each of the intake and exhaust valves; and
a processor adapted to engage the selectively actuable valve actuator when regeneration of the exhaust after-treatment device is desired, the processor causing the engine to employ an enhanced combustion cycle when exhaust after-treatment device regeneration is desired.

19. The diesel engine of claim 18, wherein the enhanced combustion cycle includes one intake stroke, three compression strokes, three expansion strokes, and one exhaust stroke, with a combustion event associated with each pair of compression and expansion strokes.

20. The diesel engine of claim 18, wherein the selectively actuable valve actuator is one of a cam follower with lost motion capability and an electrical valve actuator.
